(19) United States
(12) Patent Application Publication
(10) Pub. No.: US 2018/0261182 A1
(43) Pub. Date: Sep. 13, 2018

(54) DISPLAY APPARATUS, DISPLAY SYSTEM, AND NON-TRANSITORY COMPUTER READABLE MEDIUM STORING PROGRAM

(71) Applicant: FUJI XEROX CO., LTD., Tokyo (JP)

(72) Inventors: Soichiro ZOSHI, Kanagawa (JP); Kiyoshi TERAGUCHI, Kanagawa (JP)

(73) Assignee: FUJI XEROX CO., LTD., Tokyo (JP)

(21) Appl. No.: 15/796,864

(22) Filed: Oct. 30, 2017

(30) Foreign Application Priority Data
Mar. 7, 2017 (JP) 2017-042727

(51) Int. Cl. G09G 5/00

(52) U.S. Cl. CPC G09G 5/003; G06K 9/00604

(57) ABSTRACT

A display apparatus includes a first acquisition unit that acquires a display history showing a history of an image displayed on a display screen of a terminal, a second acquisition unit that acquires a gazing point history showing a history of a gazing point of an inspector directed into the display screen, a third acquisition unit that acquires an operation history showing a history of an operation of the inspector on the terminal, an extraction unit that extracts an operation from the operation history, and a display controller that displays on a display, a figure indicating the gazing point during a period corresponding to the extracted operation so as to be superimposed on the image displayed on the display screen during the period, on the basis of the display history and the gazing point history.

### CROSS-REFERENCE TO RELATED APPLICATIONS

This application is based on and claims priority under 35 USC 119 from Japanese Patent Application No. 2017-042727 filed Mar. 7, 2017.

### BACKGROUND

### Technical Field

The present invention relates to a display apparatus, a display system, and a non-transitory computer readable medium storing a program.

### SUMMARY

According to an aspect of the invention, there is provided a display apparatus including a first acquisition unit that acquires a display history showing a history of an image displayed on a display screen of a terminal; a second acquisition unit that acquires a gazing point history showing a history of a gazing point of an inspector directed into the display screen; a third acquisition unit that acquires an operation history showing a history of an operation of the inspector on the terminal; an extraction unit that extracts an operation from the operation history; a display controller that displays on a display, a figure indicating the gazing point during a period corresponding to the extracted operation so as to be superimposed on the image displayed on the display screen during the period, on the basis of the display history and the gazing point history.

### BRIEF DESCRIPTION OF THE DRAWINGS

Exemplary embodiment (s) of the present invention will be described in detail based on the following figures, wherein:

FIG. 1 is a diagram showing an overall configuration of a display system 9 according to the present exemplary embodiment;

FIG. 2 is a diagram showing an example of a configuration of an image reading device 3;

FIG. 3 is a diagram showing a configuration of a terminal 2;

FIG. 4 is a diagram showing an example of an image DB 221;

FIG. 5 is a diagram showing a configuration of a display apparatus 1;

FIG. 6 is a diagram showing an example of a display history DB 121;

FIG. 7 is a diagram showing an example of a gazing point history DB 122;

FIG. 8 is a diagram showing an example of an operation history DB 123;

FIG. 9 is a diagram showing an example of an inspection item DB 124;

FIG. 10 is a diagram showing an example of a guide area DB 125;

FIG. 11 is a diagram showing a functional configuration of the display apparatus 1;

FIG. 12 is a diagram showing an example of an image displayed to a verifier by the display apparatus 1;

FIG. 13 is a flowchart for explaining the flow of the operation of the display apparatus 1;

FIG. 14 is a diagram showing an example of display in a case where the controller 11 evaluates the inspector's inspection highly;

FIG. 15 is a diagram showing an example of display in a case where the controller 11 evaluates the inspector's inspection lowly;

FIG. 16 is a diagram showing an example of a configuration of a server apparatus 5; and

FIG. 17 is a diagram showing a functional configuration of a display apparatus 1 in Modification Example 1.

### DETAILED DESCRIPTION

### 1. Exemplary Embodiment

### 1-1. Overall Configuration of Display System

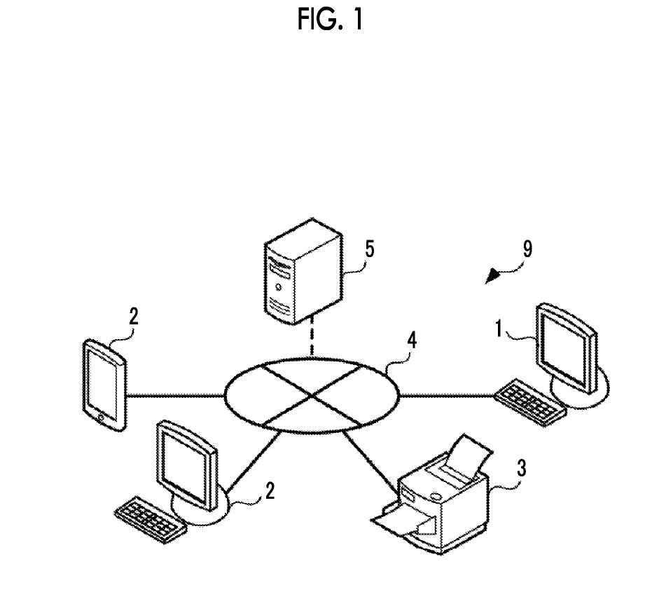

FIG. 1 is a diagram showing an overall configuration of a display system 9 according to the present exemplary embodiment. The display system 9 includes a communication line 4 forming a local area network (LAN) and a wide area network (WAN), or the like, and a display apparatus 1, terminals 2, and an image reading device 3, which are connected to the communication line 4.

The image reading device 3 shown in FIG. 1 is connected to the terminal 2 through a communication line 4. The image reading device 3 reads an image formed on a medium or the like, generates image data indicating the image, and transmits the image data to the terminal 2. The number of image reading devices 3 included in the display system 9 may be one as shown in FIG. 1, or plural.

The terminal 2 shown in FIG. 1 is an information processing apparatus which displays the image indicated by the image data transmitted from the image reading device 3 on the display screen and allows the user to inspect the image. The user of terminal 2 is also called “inspector”. The inspector is a user who uses the terminal 2 to inspect the image displayed on the terminal 2. The terminal 2 detects the inspector's gazing point when the inspector inspects the displayed image, and receives the inspector's operation according to the result of inspection. The number of terminals 2 included in the display system 9 may be two as shown in FIG. 1, one, or three or more.

The display apparatus 1 shown in FIG. 1 is used to acquire the history of the image displayed on the display screen of the terminal 2, the history of the inspector's gazing point directed into the display screen, and the history of the operation of the inspector, and displays the gazing point gazed at the time of inspection so as to be superimposed on the image inspected by the inspector. The user of the display apparatus 1 also called “verifier”. The verifier is a user who verifies the image inspected by the inspector and the gazing point gazed at the time of inspection by using the display apparatus 1 and verifies the contents of the inspector's inspection. The number of display apparatuses 1 included in the display system 9 may be one as shown in FIG. 1, or plural.

### 1-2. Configuration of Image Reading Device

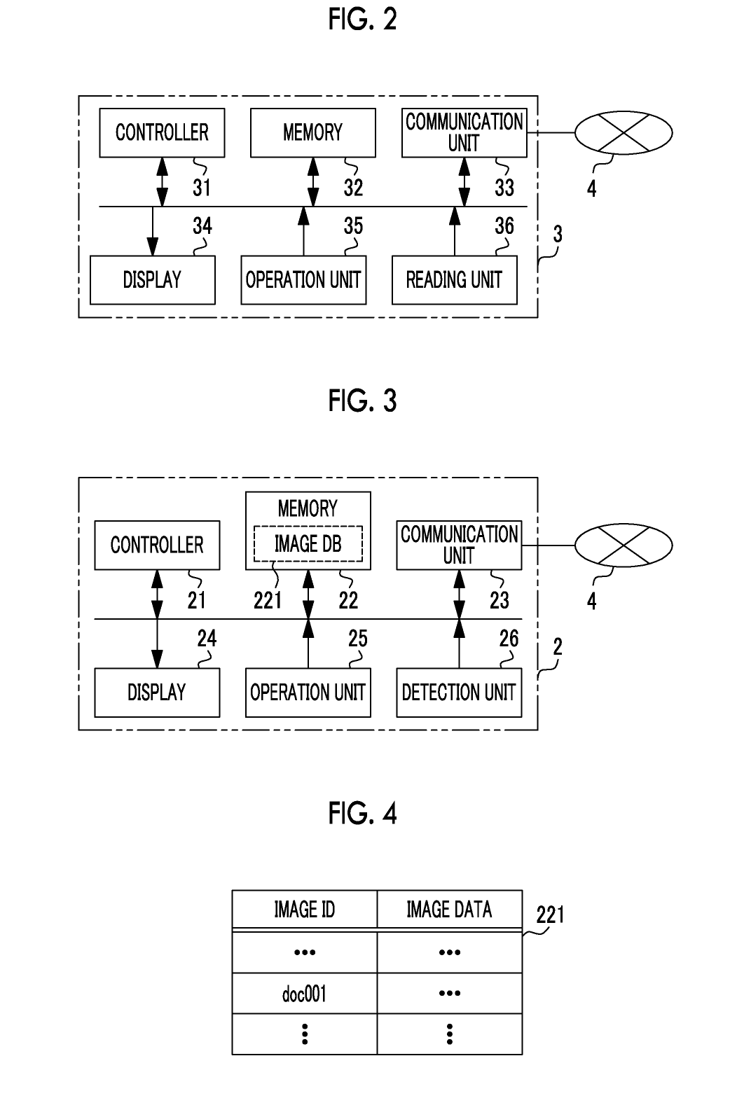

FIG. 2 is a diagram showing an example of a configuration of the image reading device 3. The image reading device 3 includes a controller 31, a memory 32, a communication unit 33, a display 34, an operation unit 35, and a reading unit 36.

The controller 31 includes a central processing unit (CPU), a read only memory (ROM), and a random access memory (RAM), and the CPU reads out and executes the computer program (hereinafter referred to simply as “program”) stored in the ROM or the memory 32 to control each part of the image reading device 3.

The memory 32 is a large-capacity storage unit such as a solid state drive, and stores various programs which are read into the CPU of the controller 31.

The communication unit 33 is a communication circuit which is connected to the communication line 4 by wireless or wired. The image reading device 3 exchanges information with the terminal 2 through the communication line 4 by the communication unit 33.

The operation unit 35 is equipped with operators such as operation buttons for giving various instructions, receives an operation by a user, and supplies a signal corresponding to the operation contents to the controller 31. Further, the operation unit 35 may include a touch panel for detecting an operator such as a user's finger or a stylus pen.

The display 34 includes a liquid crystal display, and displays an image under the control of the controller 31. A transparent touch panel of the operation unit 35 may be disposed so as to be superimposed on the liquid crystal display of the display 34.

The image reading device 3 may receive an operation from an external operation terminal through the communication line 4, for example. When receiving an operation from the external operation terminal, the image reading device 3 may not include the operation unit 35. Further, the image reading device 3 may not include the display 34.

The reading unit 36 is, for example, an image scanner, and optically reads a document to generate image data. The reading unit 36 may be provided with a document feeder that feeds stacked documents one by one to a reading position.

### 1-3. Configuration of Terminal

FIG. 3 is a diagram showing a configuration of the terminal 2. The terminal 2 includes a controller 21, a memory 22, a communication unit 23, a display 24, an operation unit 25, and a detection unit 26.

The controller 21 includes a CPU, a ROM, and a RAM, and the CPU reads out and executes the program stored in the ROM or the memory 22 to control each part of the terminal 2.

The memory 22 is a large-capacity storage unit such as a hard disk drive, and stores various programs which are read into the CPU of the controller 21.

The memory 22 also includes an image DB 221 which is a database for storing image data indicating the image sent from the image reading device 3.

FIG. 4 is a diagram showing an example of the image DB 221. The image DB 221 stores image data indicating each of plural images in association with an image ID which is identification information for identifying the image. In a case where the image reading device 3 sequentially reads one sheet at a time from a document configured with plural sheets to generate image data, the plural generated image data items constituting a single document may be stored in the image DB 221 in association with the document.

The communication unit 23 is a communication circuit which is connected to the communication line 4 by wireless or wired. The terminal 2 exchanges information with the display apparatus 1 and the image reading device 3 through the communication line 4 by the communication unit 23.

The operation unit 25 is equipped with operators such as operation buttons for giving various instructions, receives an operation by an inspector, and supplies a signal corresponding to the operation contents to the controller 21. Further, the operation unit 25 may include a touch panel for detecting an operator such as a finger of an inspector or a stylus pen.

The display 24 includes a display screen such as a liquid crystal display, and displays an image under the control of the controller 21. A transparent touch panel of the operation unit 25 may be disposed so as to be superimposed on the display screen of the display 24.

The detection unit 26 detects the position on the display screen gazed by the inspector, that is, the gazing point. The detection unit 26 may detect the gazing point by imaging the inspector's pupil, or may regard the point indicated by the operation of the mouse cursor, the laser pointer, the touch pen or the like as the gazing point. The detection unit 26 may be, for example, a wearable device such as a glasses type worn by an inspector, or may be a fixed camera for imaging the pupil of an inspector.

The detection unit 26 may detect the gazing point by imaging the inspector's pupil at a predetermined cycle such as every 10 milliseconds, for example. The detection unit 26 may detect the gazing point when the gazing point moves at a predetermined speed or more.

### 1-4. Configuration of Display Apparatus

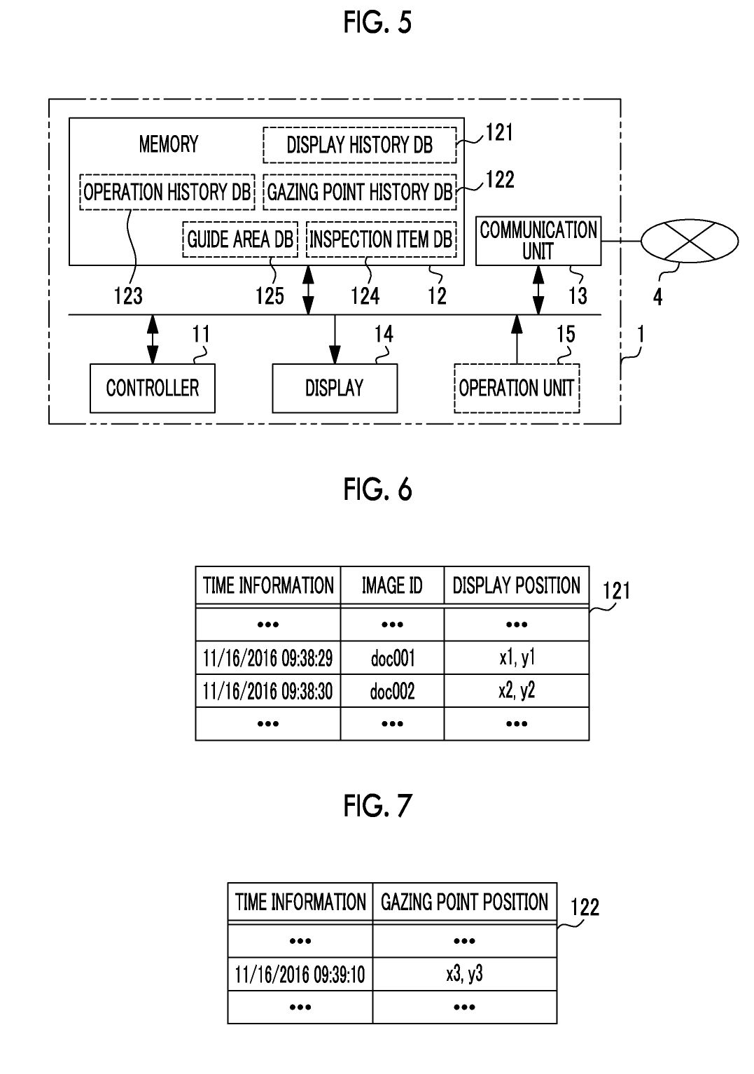

FIG. 5 is a diagram showing a configuration of the display apparatus 1. The display apparatus 1 includes a controller 11, a memory 12, a communication unit 13, a display 14, and an operation unit 15.

The controller 11 includes a CPU, a ROM, and a RAM, and the CPU reads out and executes the program stored in the ROM or the memory 12 to control each part of the display apparatus 1.

The communication unit 13 is a communication circuit which is connected to the communication line 4 by wireless or wired. The display apparatus 1 exchanges information with the terminal 2 through the communication line 4 by the communication unit 13.

The operation unit 15 is equipped with operators such as operation buttons for giving various instructions, receives an operation by a verifier, and supplies a signal corresponding to the operation contents to the controller 11. Further, the operation unit 15 may include a touch panel for detecting an operator such as a finger of a verifier or a stylus pen.

The display 14 includes a display screen such as a liquid crystal display, and displays an image under the control of the controller 11. A transparent touch panel of the operation unit 15 may be disposed so as to be superimposed on the display screen of the display 14.

The memory 12 is a large-capacity storage unit such as a hard disk drive, and stores various programs which are read into the CPU of the controller 11. Further, the memory 12 stores a display history DB 121, a gazing point history DB 122, and an operation history DB 123. Further, as shown in FIG. 5, the memory 12 may store an inspection item DB 124 and a guide area DB 125.

FIG. 6 is a diagram showing an example of the display history DB 121. The display history DB 121 is a database that stores a display history showing the history of images displayed on the display screen of the terminal 2. As shown in FIG. 6, in the display history DB 121, “image ID” indicating the identification information of the image displayed on the display screen of the display 24 of the terminal 2 and “display position” indicating the position at which the image is displayed are stored in association with “time information” indicating the time at which the image is displayed.

In the example shown in FIG. 6, for example, the display history DB 121 stores that the image having the image ID “doc001” is displayed at the time “2016/11/16 09: 38: 29” in the display position “x1, y1” of the display screen.

In addition to the information shown in FIG. 6, the display history DB 121 may store, for example, an image enlarging rate and direction, a rotation direction, or the like. In short, the display history DB 121 may store information capable of identifying a time, a part, and a pixel at which the image is displayed on the display screen of the terminal 2.

FIG. 7 is a diagram showing an example of the gazing point history DB 122. The gazing point history DB 122 is a database that stores a gazing point history showing the history of the inspector's gazing point directed into the display screen of the terminal 2. As shown in FIG. 7, in the gazing point history DB 122, based on the detection result of the detection unit 26 of the terminal 2, the “gazing point position” indicating the position that the inspector gazes at on the display screen of the display 24 is stored in association with “time information” indicating the time when the inspector gazes at.

In the example shown in FIG. 7, for example, the gazing point history DB 122 stores that the inspector gazes at the gazing point position “x3, y3” of the display screen at the time “2016/11/16 09:39:10”.

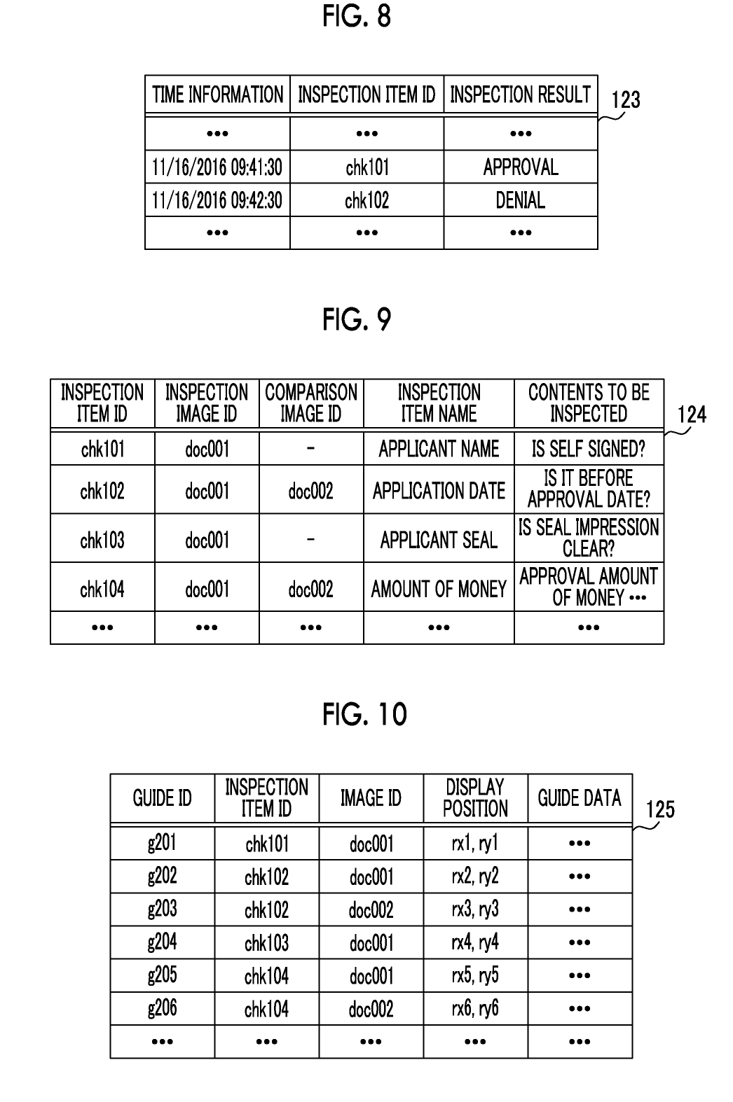

FIG. 8 is a diagram showing an example of the operation history DB 123. The operation history DB 123 is a database that stores an operation history of a history of an operation of an inspector on the terminal 2. As shown in FIG. 8, in the operation history DB 123, “inspection item ID” which is identification information for each of items of inspection (inspection item) which is performed by the inspector operating the operation unit 25 of the terminal 2″ and “inspection result” which is the result of the inspector's inspection for the inspection item are stored in association with “time information” indicating the time when the inspection is performed.

In the example shown in FIG. 8, for example, the operation history DB 123 stores that the inspector performs an operation indicating the inspection result “approval” for the item with the inspection item ID “chk101” at time “2016/11/16 09: 38: 28”.

FIG. 9 is a diagram showing an example of the inspection item DB 124. The inspection item DB 124 is a database that stores the contents of the inspection and the image to be viewed and checked by the inspector in association with each other, for each item of inspection. As shown in FIG. 9, in the inspection item DB 124, “inspection item ID” which is identification information for each item of inspection, “inspection image ID” which is identification information of an image to be inspected, “comparison image ID” which is the identification information of a comparison image in a case where there is an image to be compared (the comparison image) in the inspection, “inspection item name” which is the name of the item of the inspection, and contents to be inspected in the item of the inspection are stored in association with each other.

In the example shown in FIG. 9, for example, in the inspection item DB 124, in the inspection identified by the inspection item ID “chk104”, it is stored that for the inspection item name “amount of money”, the inspector is to compare the inspection image identified by the inspection image ID “doc001” with the comparison image identified by the comparison image ID “doc002” and perform inspection from the viewpoint of the inspection contents as to “whether or not it matches the approval amount of money”.

FIG. 10 is a diagram showing an example of the guide area DB 125. The guide area DB 125 is a database that stores an inspection image to be checked for each inspection item, and in some cases, the positions (display positions) at which guides such as frames indicating the areas to be gazed with respect to a comparison image and data of the guides (guide data) in association with “guide IDs” which are the identification information of the guides, respectively.

In the example shown in FIG. 10, for example, in the guide area DB 125, it is stored that the guide identified by the guide ID “g205” is a guide for guiding the inspection item ID “chk104”, and indicates an area indicating the display position “rx5, ry5” to be superimposed on the image identified by the image ID “doc 001”. The guide data may store the color and shape of the guide.

By combining the inspection item DB 124 with the guide area DB 125, it is possible to recognize which area of the image should be gazed for each item of inspection. This area is an area associated with each operation for an image displayed on the terminal 2 at the time of inspection.

### 1-5. Functional Configuration of Display Apparatus

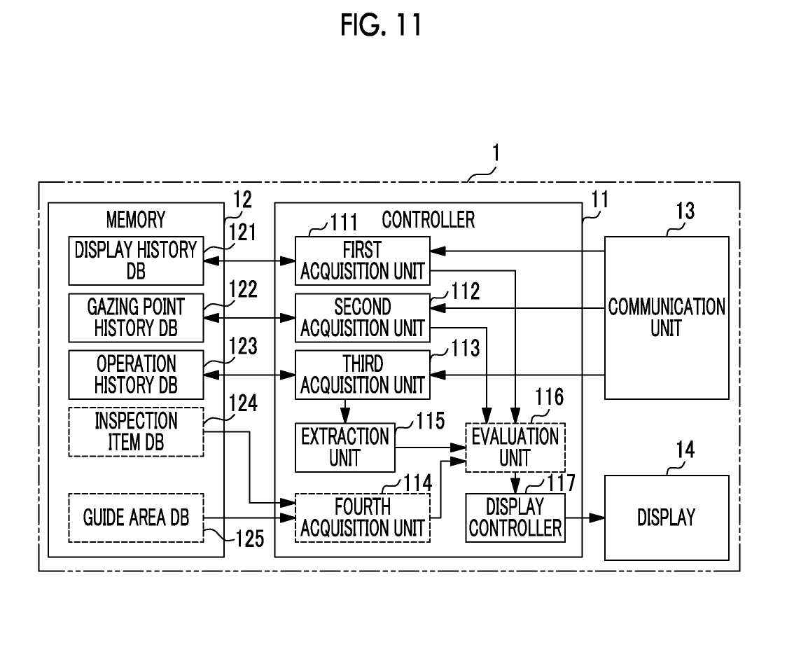

FIG. 11 is a diagram showing a functional configuration of the display apparatus 1. The controller 11 of the display apparatus 1 shown in FIG. 11 executes the program stored in the memory 12, thereby functioning as a first acquisition unit 111, a second acquisition unit 112, a third acquisition unit 113, an extraction unit 115, and a display controller 117. Further, as shown in FIG. 11, the controller 11 may function as a fourth acquisition unit 114 and an evaluation unit 116 in addition to these.

The first acquisition unit 111 acquires the display history showing the history of the image displayed on the display screen of the display 24 of the terminal 2. The first acquisition unit 111 acquires the display history from the terminal 2 through the communication unit 13, and stores it in the display history DB 121 of the memory 12. In addition, the first acquisition unit 111 acquires the display history from the display history DB 121 according to the operation on the operation unit 15 (see FIG. 5) of the display apparatus 1 by the verifier. In addition, the first acquisition unit 111 may acquire the display history determined from the display history DB 121 at a determined time, for example, without depending on the operation of the verifier.

The second acquisition unit 112 acquires the gazing point history showing the history of the inspector's gazing point directed into the display screen of the display 24 of terminal 2. The second acquisition unit 112 acquires the gazing point history from the terminal 2 through the communication unit 13, and stores it in the gazing point history DB 122 of the memory 12. In addition, the second acquisition unit 112 acquires the gazing point history from the gazing point history DB 122 according to the operation of the verifier.

The third acquisition unit 113 acquires an operation history showing the history of the operation of the inspector for the operation unit 25 of the terminal 2. The third acquisition unit 113 acquires the operation history from the terminal 2 through the communication unit 13, and stores it in the operation history DB 123 of the memory 12. The third acquisition unit 113 acquires the operation history from the operation history DB 123 according to the operation of the verifier.

The extraction unit 115 extracts an operation corresponding to each item of inspection from the operation history acquired by the third acquisition unit 113.

The display controller 117 displays a figure indicating the gazing point during a period corresponding to the extracted operation so as to be superimposed on the image displayed on the display screen of the display 24 of the terminal 2 during the period, on the display 14, on the basis of the acquired display history and gazing point history.

The fourth acquisition unit 114 acquires area information indicating an area associated with each operation in the image to be inspected. For example, as shown in FIG. 11, the fourth acquisition unit 114 refers to the inspection item DB 124 and the guide area DB 125 and acquires area information indicating an area of an image to be gazed for each item of inspection. In this case, the display controller 117 displays the area indicated by the acquired area information so as to be superimposed on the image displayed in the period corresponding to the above-described operation.

The evaluation unit 116 evaluates the inspector's inspection, based on the area displayed by the display 14 and the gazing point.

For example, the evaluation unit 116 may evaluate the inspection by the inspector highly, as the time during which the gazing point is present inside the area is longer.

In a case where the controller 11 functions as the evaluation unit 116, the display controller 117 may display the image in accordance with the result of evaluation by the evaluation unit 116.

For example, with respect to the inspection item of which evaluation result by the evaluation unit 116 is a high evaluation, the display controller 117 may display the image corresponding to the inspection item earlier. That is, the display controller 117 may rearrange the order of the inspection item verified by the verifier according to the result of evaluation by the evaluation unit 116.

Further, for example, in a case where the evaluation result by the evaluation unit 116 is a low evaluation that is lower than the threshold value, the display controller 117 may display a character or a figure indicating a warning superimposed on the image corresponding to the inspection item. Further, in a case where the evaluation result by the evaluation unit 116 is a high evaluation that exceeds the threshold value, the display controller 117 may not display the image corresponding to the inspection item.

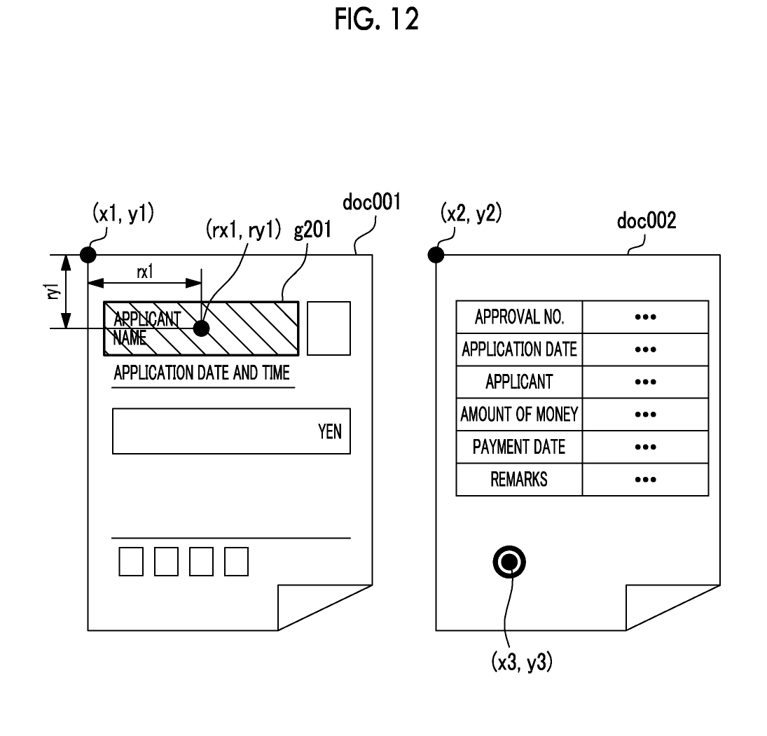

FIG. 12 is a diagram showing an example of an image displayed to a verifier by the display apparatus 1. The controller 11 of the display apparatus 1 acquires the display history, the gazing point history, and the operation history, and extracts the operation corresponding to each inspection item from the operation history. The controller 11 specifies the image ID of the image displayed on the terminal 2 and the position (display position) at which the image is displayed during the period of the operation, based on the display history, and displays the image at the display position on the display 14.

Further, the controller 11 specifies the gazing point on the display screen of the display 24 that the inspector gazes at during the period of above-mentioned operation, based on the gazing point history, and displays a figure indicating this gazing point on the display 14.

In addition, the controller 11 acquires the guide data for each inspection item from the inspection item DB 124 and the guide area DB 125 of the memory 12, and displays the guide indicated by the guide data so as to be superimposed on above-mentioned image, on the display 14.

In the example shown in FIG. 12, the image and the gazing points, which are displayed when inspection is performed for the inspection item ID “chk101” at the terminal 2, are reproduced. At time “2016/11/16 09: 41: 30” shown in FIG. 8, the inspector performs an “approval” operation as the inspection result for the inspection item ID “chk101”. At this time, the image with the image ID “doc001” is displayed at the display position “x1, y1”, and the image with the image ID “doc002” is displayed at the display position “x2, y2”. Then, the inspector sees the gazing point “x3, y3” at “2016/11/16 09: 39: 10” before performing the above “approval” operation.

Further, the identification information of the guide corresponding to above-mentioned inspection item ID “chk101” is the guide ID “g201” and is displayed at the display position “rx1, ry1”.

### 1-6. Operation of Display Apparatus

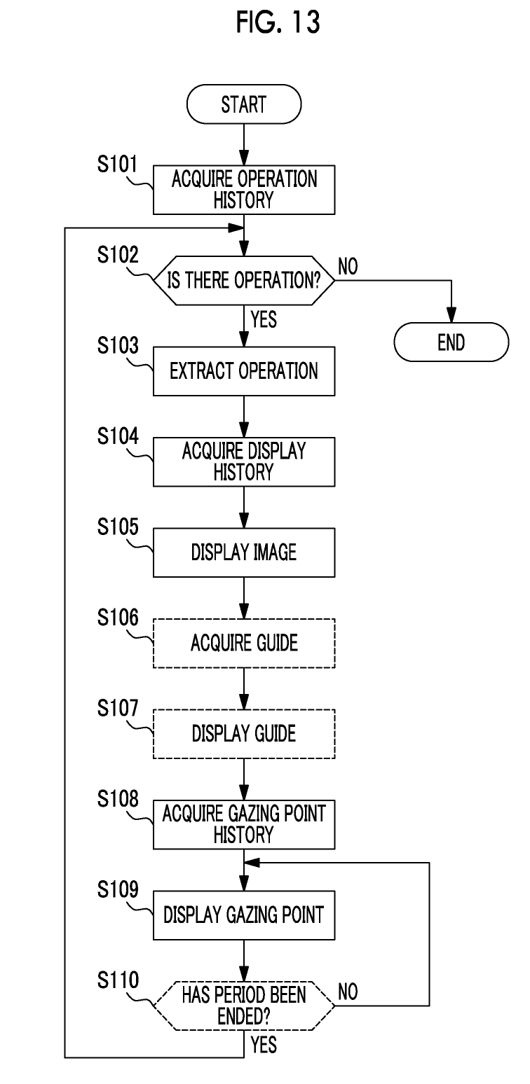

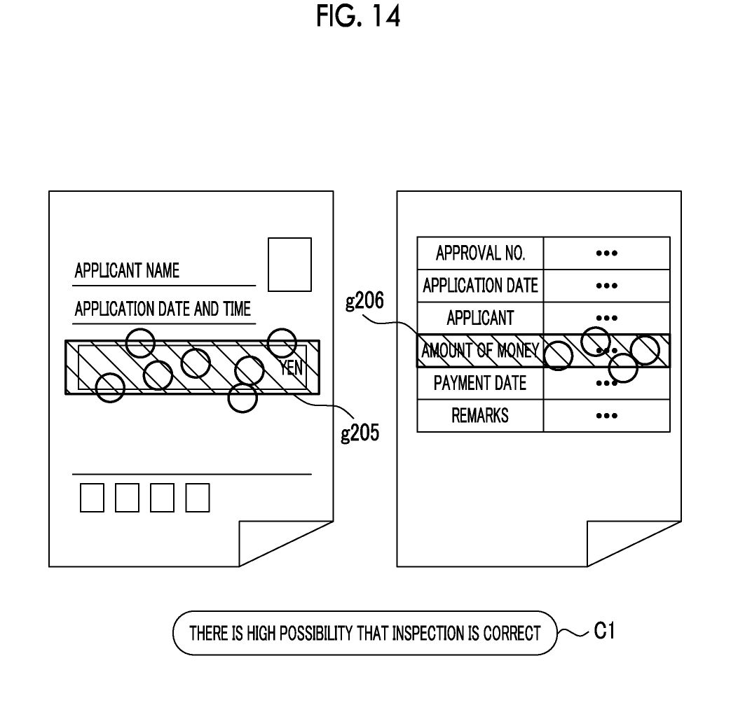

FIG. 13 is a flowchart for explaining the flow of the operation of the display apparatus 1. The controller 11 of the display apparatus 1 acquires the operation history (step S101), and determines whether or not the operation to be extracted remains in the operation history (step S102). In a case where it is determined that no operation to be extracted remains (step S102; NO), the controller 11 terminates the process.

On the other hand, in a case where it is determined that an operation to be extracted remains in the operation history (step S102; YES), the controller 11 extracts the operation for each inspection item from the operation history (step S103).

The controller 11 acquires the display history (step S104), and displays on the display 14, the image displayed on the terminal 2 during the above-mentioned operation, based on the display history (step S105).

The controller 11 acquires a guide associated with the inspection item targeted by the above-described operation from the memory 12 (step S106), and displays the guide on the display 14 (step S107).

The controller 11 acquires the gazing point history (step S108), and displays on the display 14, the gazing point gazed by the inspector during the above-described operation (step S109).

The controller 11 determines whether or not above-mentioned period has been ended (step S110). While it is determined that the period has not ended (step S110; NO), the controller 11 returns to step S109 to display a gazing point. Thus, if there is a movement of the gazing point during the period, the movement is reproduced. On the other hand, if it is determined that the period has ended (step S110; YES), the controller 11 returns control to step S102. Thus, while an unextracted operation remains in the operation history, the image and the movement of the gazing point displayed, and the guide are displayed for each operation.

With the above operation, the display apparatus 1 of the display system 9 displays the displayed image and the position that the inspector gazes at during the inspection period, for each item of inspection performed by the inspector, so it becomes easier for the verifier to verify whether the inspection by the inspector is performed correctly or not. Further, in a case of displaying the guides according to inspection items, the verifier performs verification with reference to the guide.

In a case where it is not necessary to reproduce the movement of the inspector's gazing point in above-mentioned period, the controller 11 may not make the determination in step S110. In this case, the positions where the gazing points are present during the operation period for each inspection item are superimposed and displayed on the display 14.

Further, the controller 11 of the display apparatus 1 may evaluate the inspector's inspection based on the area where the guide is displayed and the gazing point, and display the evaluation result on the display 14.

FIG. 14 is a diagram showing an example of display in a case where the controller 11 evaluates the inspector's inspection highly. The inspection of inspection item ID “chk104” is to inspect whether or not the amount of money matches the approval amount of money, as shown in FIG. 9. For this inspection, as shown in FIG. 10, guides of guide IDs “g205” and “g206” are prepared. Thus, as shown in FIG. 14, two guides of guide IDs “g205” and “g206” are displayed on the display 14 of the display apparatus 1. These two guides inform the verifier that the inspector should have inspected whether the amounts of money stated in the inside thereof match or not.

The gazing points shown in FIG. 14 are included more inside above-mentioned two guides than the outside. This means that the time during which the gazing points are present inside the area indicated by the guide is longer than the time during which the gazing points are present outside thereof, over the period of inspection. Therefore, there is a high possibility that the inspector gazes at the area to be gazed during the inspection. The display apparatus 1 evaluates the inspection highly from the relationship between the guide and the gazing point, and displays, for example, as shown in FIG. 14, a comment C1 that “There is a high possibility that the inspection is correct”.

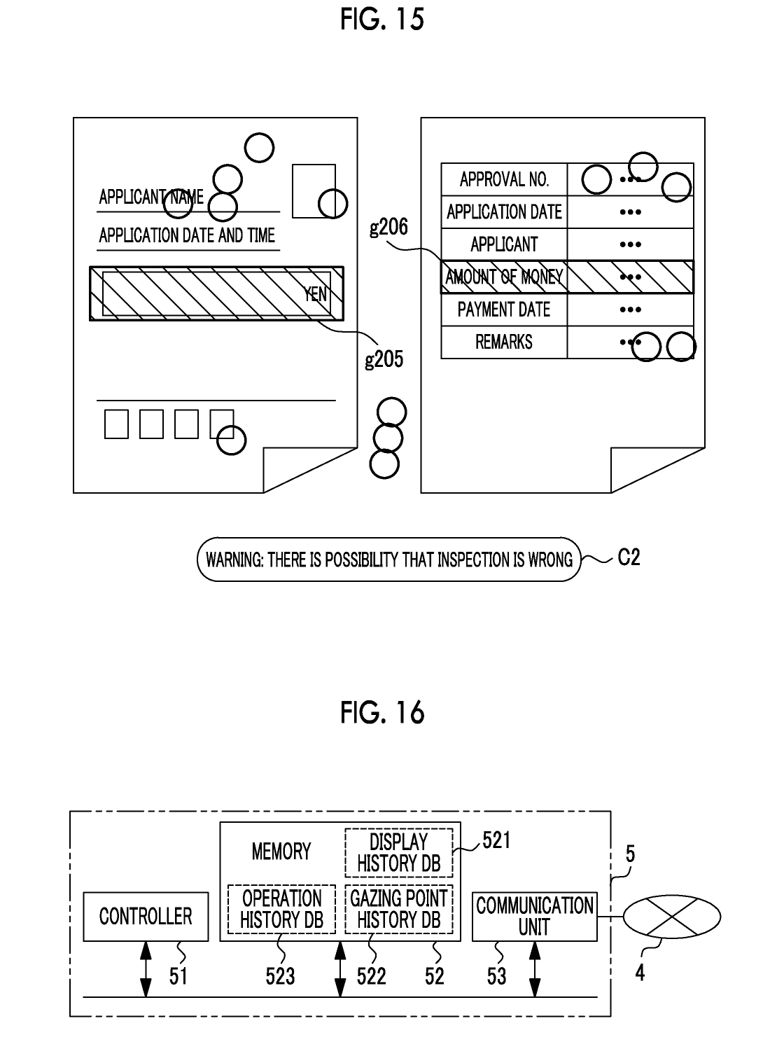

On the other hand, FIG. 15 is a diagram showing an example of display in a case where the controller 11 evaluates the inspector's inspection lowly. All the gazing points shown in FIG. 15 are present outside above-mentioned two guides. Therefore, there is a high possibility that the inspector does not gaze at the area to be gazed during the inspection. The display apparatus 1 evaluates the inspection lowly from the relationship between the guide and the gazing point, and displays, for example, as shown in FIG. 15, a comment C2 that “WARNING: There is a possibility that the inspection is wrong”.

With reference to the display, when the gazing point is far from the area indicated by the guide beyond the threshold value, the verifier more carefully verifies the inspection as compared with the case where the gazing point is included in the area indicated by the guide, so the burden on the verifier is reduced.

### 2. Modification Examples

The above is an explanation of an exemplary embodiment, but the contents of the exemplary embodiment can be modified as follows. In addition, the following modification examples may be combined.

### 2-1. Modification Example 1

In above-described exemplary embodiment, the display apparatus 1 of the display system 9 directly acquires the display history, the gazing point history, and the operation history from the terminal 2 through the communication line 4, but may acquire them by being relayed by other devices. For example, as indicated by a dashed line in FIG. 1, the display system 9 may include a server apparatus 5 which is connected to the display apparatus 1 and the terminal 2 and accumulates the operation history at the terminal 2 and provides it to the display apparatus 1.

FIG. 16 is a diagram showing an example of a configuration of the server apparatus 5. The server apparatus 5 shown in FIG. 16 includes a controller 51, a memory 52, and a communication unit 53. These functions correspond to the controller 11, the memory 12, and the communication unit 13 of the display apparatus 1 in the above-described exemplary embodiment.

The memory 52 stores a display history DB 521, a gazing point history DB 522, and an operation history DB 523. These correspond to the display history DB 121, the gazing point history DB 122, and the operation history DB 123, which are stored in the memory 12 in the above-described exemplary embodiment, respectively. In a case where the memory 52 stores these databases, the memory 12 of the display apparatus 1 may not store these databases.

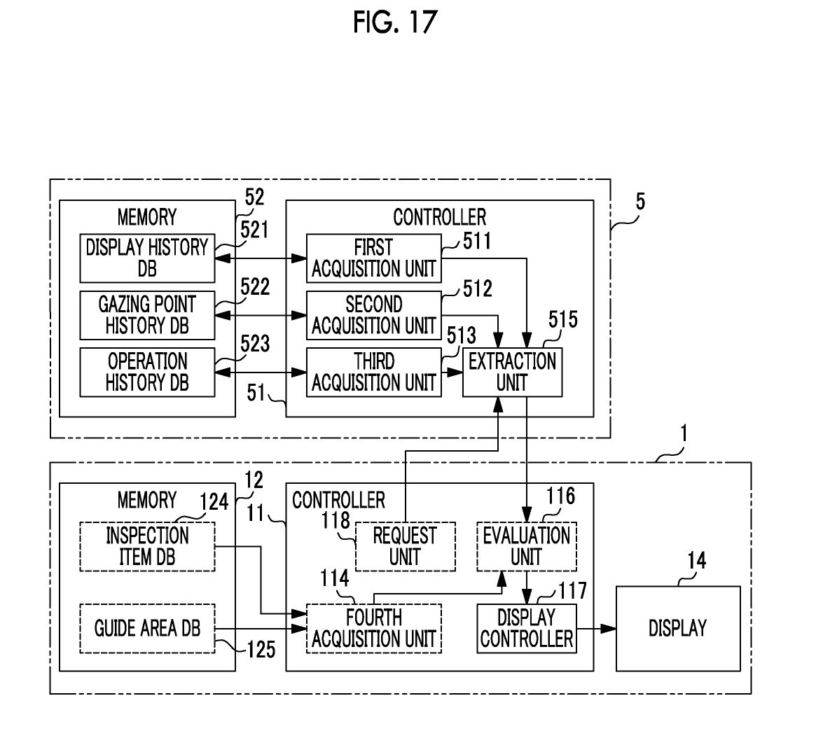

FIG. 17 is a diagram showing a functional configuration of a display apparatus 1 in Modification Example 1. The controller 51 of the server apparatus 5 functions as a first acquisition unit 511, a second acquisition unit 512, a third acquisition unit 513, and an extraction unit 515 by executing the program stored in the memory 52. The functions of the first acquisition unit 111, the second acquisition unit 112, the third acquisition unit 113, and the extraction unit 115 shown in FIG. 11 are realized by the controller 51 of the server apparatus 5.

In this case, the controller 51 of the server apparatus 5 extracts the operation for each inspection item from the acquired operation history, specifies the image displayed by the terminal 2 in the period corresponding to each operation and the gazing point that the inspector gazes at, on the basis of the acquired display history and gazing point history, and sends information indicating these to the controller 11 of the display apparatus 1.

The controller 11 of the display apparatus 1 functions as the display controller 117 that displays a figure showing the inspector's gazing point on the display 14 so as to be superimposed on the image displayed on the terminal 2 during above-mentioned period. That is, in this modification example, some of the functions of the controller 11 shown in the exemplary embodiment are realized by the controller 51.

In the modification example, the display system 9 includes a terminal 2 including a display screen, a server apparatus 5 that communicates with the terminal 2, and a display apparatus 1 that communicates with the server apparatus 5, the server apparatus 5 includes a first acquisition unit 511 that acquires a display history showing a history of an image displayed on the display screen of the terminal 2, a second acquisition unit 512 that acquires a gazing point history showing a history of a inspector's gazing point directed into the display screen, a third acquisition unit 513 that acquires an operation history showing a history of an operation of the inspector on the terminal 2, and an extraction unit 515 that extracts an operation from the operation history. In the Modification Example, the display apparatus 1 includes a display controller 117 that displays a figure indicating the gazing point during a period corresponding to the extracted operation so as to be superimposed on the image displayed on the display screen during the period, on a display, on the basis of the display history and the gazing point history.

The controller 11 may function as the request unit 118 that requests the server apparatus 5 for information indicating an operation for each inspection item and information on the image and gazing point corresponding to the operation. In this case, the extraction unit 515 may extract the operation in response to the request of the request unit 118, and provide information indicating the extracted operation to the display apparatus 1.

Even in this case, as shown in FIG. 17, the controller 11 may function as the fourth acquisition unit 114 and the evaluation unit 116.

### 2-2. Modification Example 2

In the above-described exemplary embodiment, the fourth acquisition unit 114 that acquires area information functions as the fourth acquisition unit 114, and the function as the fourth acquisition unit 114 may be omitted.

For example, in a case where the verifier is familiar with the contents of the inspection, the display apparatus 1 may not display the guide. In this case, the controller 11 may not function as the fourth acquisition unit 114, and the memory 12 may not store the inspection item DB 124 and the guide area DB 125. Then, the controller 11 may not perform step S106 and step S107 shown in FIG. 13.

### 2-3. Modification Example 3

In above-mentioned exemplary embodiment, the controller 11 of the display apparatus 1 functions as the evaluation unit 116 that evaluates the inspection by the inspector, on the basis of the area which is indicated by the area information acquired by the fourth acquisition unit 114 and is displayed by the display 14 and the gazing point, but the function as the evaluation unit 116 may be omitted.

### 2-4. Modification Example 4

Above-mentioned exemplary embodiment illustrates an example of the evaluation unit 116 that evaluates the inspection by the inspector highly as the time during which the gazing point is present inside the area is longer, but the evaluation criterion by the evaluation unit 116 is not limited thereto. For example, in the case where the moving speed and the acceleration of the gazing point when the gazing point is present inside the area satisfy the determined conditions, the evaluation unit 116 may evaluate the inspector's inspection highly.

In addition, the display controller 117 may display a figure indicating a gazing point in a manner corresponding to the time when the inspector's line of sight is directed. For example, as the time during which the inspector's line of sight is directed into is longer, the figure indicating the gazing point where the line of sight is directed into may be displayed with darker color on the display 14.

### 2-5. Modification Example 5

In above-mentioned exemplary embodiment, the display controller 117 displays the image in accordance with the result of evaluation by the evaluation unit 116, but the controller 11 may present information according to the result of the evaluation by the evaluation unit 116 to the inspector, in a way other than displaying an image. For example, the display apparatus 1 includes a device that outputs sound, such as a speaker, and the controller 11 may output sound corresponding to the result of evaluation by the evaluation unit 116.

### 2-6. Modification Example 6

In above-mentioned exemplary embodiment, the display apparatus 1 and the terminal 2 are separate entities, but the display apparatus 1 may have the function of the terminal 2.

### 2-7. Modification Example 7

The program executed by the controller 11 of the display apparatus 1 can be provided by being stored in a computer readable recording medium such as a magnetic recording medium such as a magnetic tape or a magnetic disk, an optical recording medium such as an optical disk, a magneto-optical recording medium, and a semiconductor memory. It is also possible to download the program through a communication line such as the Internet. As control means exemplified by the controller 11, various devices other than the CPU may be applied, for example, a dedicated processor or the like is used.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A display apparatus comprising:
a first acquisition unit that acquires a display history showing a history of an image displayed on a display screen of a terminal;
a second acquisition unit that acquires a gazing point history showing a history of a gazing point of an inspector directed into the display screen;
a third acquisition unit that acquires an operation history showing a history of an operation of the inspector on the terminal;
an extraction unit that extracts an operation from the operation history; and
a display controller that displays on a display, a figure indicating the gazing point during a period corresponding to the extracted operation so as to be superimposed on the image displayed on the display screen during the period, on a basis of the display history and the gazing point history.

2. The display apparatus according to claim 1, further comprising:
a fourth acquisition unit that acquires area information indicating an area associated with each operation in the image,
wherein the display controller displays the area associated with each operation so as to be superimposed on the image displayed during the period corresponding to the operation.

3. The display apparatus according to claim 2, further comprising:
an evaluation unit that evaluates inspection by the inspector, on a basis of the area displayed on the display and the gazing point.

4. The display apparatus according to claim 3,
wherein the evaluation unit evaluates the inspection highly, as the time during which the gazing point is present inside the area is longer.

5. The display apparatus according to claim 3,
wherein the display controller displays the image according to a result of evaluation by the evaluation unit.

6. The display apparatus according to claim 4,
wherein the display controller displays the image according to a result of evaluation by the evaluation unit.

7. A display system comprising:
a terminal including a display screen;
a server apparatus that communicates with the terminal; and
a display apparatus that communicates with the server apparatus,
wherein the server apparatus includes
a first acquisition unit that acquires a display history showing a history of an image displayed on the display screen;
a second acquisition unit that acquires a gazing point history showing a history of a gazing point of an inspector directed into the display screen;
a third acquisition unit that acquires an operation history showing a history of an operation of the inspector on the terminal; and
an extraction unit that extracts an operation from the operation history, and
wherein the display apparatus includes a display controller that displays on the display, a figure indicating the gazing point during a period corresponding to the extracted operation so as to be superimposed on the image displayed on the display screen during the period, on a basis of the display history and the gazing point history.

8. A non-transitory computer readable medium storing a program causing a computer including a display to function as:
a first acquisition unit that acquires a display history showing a history of an image displayed on a display screen of a terminal;
a second acquisition unit that acquires a gazing point history showing a history of a gazing point of an inspector directed into the display screen;
a third acquisition unit that acquires an operation history showing a history of an operation of the inspector on the terminal;
an extraction unit that extracts an operation from the operation history; and
a display controller that displays on the display, a figure indicating the gazing point during a period corresponding to the extracted operation so as to be superimposed on the image displayed on the display screen during the period, on a basis of the display history and the gazing point history.
